(19) United States
(12) Patent Application Publication
(10) Pub. No.: US 2025/0128991 A1
(43) Pub. Date: Apr. 24, 2025

(54) SYNTHETIC STONE AGGLOMERATES AND METHOD FOR CREATION THEREOF

(71) Applicant: Robert Michael Hust, Coeur d'Alene, ID (US)

(72) Inventor: Robert Michael Hust, Coeur d'Alene, ID (US)

(73) Assignee: SILICA-X HOLDINGS INC, SPOKANE, WA (US)

(21) Appl. No.: 18/382,058

(22) Filed: Oct. 20, 2023

(51) Int. Cl. C04B 40/00; C04B 28/00; C04B 40/02; C04B 111/40

(52) U.S. Cl. CPC C04B 40/0032; C04B 28/006; C04B 40/0263; C04B 2111/40

(57) ABSTRACT

Methods for making synthetic stone items from industrial wastes are disclosed. Industrial wastes such as waste to energy ash are used as binders, which when mixed with activators, act as substitutes for Ordinary Portland Cement (OPC), with the same uses of OPC, to make concrete and other synthetic stone items. Methods are disclosed for seeding the industrial wastes with zeolite nuclei, allowing initial zeolite formation, and then arresting the zeolite formation, plus seeding those industrial wastes with porosity components. Then upon mixing with activators, these seeded binders result in synthetic stones with porosity and with distributed arrested zeolites all of which aid self-healing of the synthetic stone and in the permanent capture of atmospheric impurities.

### RELATED APPLICATIONS

This application claims priority to U.S. Provisional Patent Application No. 63/417,966, filed on Oct. 20, 2022 and U.S. Provisional Patent Application No. 63/421,095, filed on Oct. 31, 2022, the entire contents of which are incorporated herein by reference and U.S. Provisional Patent Application No. 63/426,772, filed on Nov. 20, 2022, the entire contents of which are incorporated herein by reference and U.S. Provisional Patent Application No. 63/426,773, filed on Nov. 20, 2022, the entire contents of which are incorporated herein.

### STATEMENT REGARDING FEDERALLY SPONSORED RESEARCH

The disclosed invention was not invented pursuant to federally funded research or development.

### BACKGROUND OF THE INVENTION

The invention relates to the synthesis and utilization of geopolymers and related alkali-activated materials. Production of synthetic stone articles may be beneficial in multiple use cases, especially synthetic stone items which are porous geopolymer zeolite agglomerates. Such agglomerates have desirable properties including workability, strength, durability, and element absorption. Described herein are improvements and technological advances in creation of porous geopolymer zeolite agglomerates as synthetic stone items.

An assortment of pre-formed synthetic stone media elements currently inhabit the market; their applications ranging from concrete articles used in construction to media for filtration and remediation. Until recently, the production of these materials predominantly relied on the deployment of Ordinary Portland Cement (OPC). OPC has a high carbon footprint primarily from the clinker process which burns stone to form clinker, releasing CO2 from the stone being burned, plus clinker kilns can emit CO2 from their heat sources, such as coal or natural gas. There is a desire to steer away from conventional synthetic stone constituents towards a selection of environmentally sympathetic alternative synthetic stone using less OPC.

Geopolymers are long-range covalently-bonded non-crystalline networks, usually inorganic. Geopolymers have workability when a geopolymer formula is mixed, prior to setting to a hard agglomeration of synthetic stone. Alkali-activated materials are hydrates, not polymers, but also have workability when a formula of precursors (binder sources and additives, and alkali or acid activators) are mixed, prior to curing and hardening into an agglomeration of synthetic stone. While not strictly the same material, geopolymer agglomerates often evolve a hybridization of geopolymers and alkali-activated materials. This disclosure focuses on geopolymer agglomerates and such hybrid agglomerates.

The invention is a range of synthetic stone items, produced from novel porous geopolymer agglomerates utilizing zeolites, created by use of a novel process to yield synthetic stone items with useful properties from mining and extraction residues, coal combustion products, metallurgical slag, waste glass, ceramic and cement industry waste, power plant residues, construction and demolition debris, clay and shale processing waste, agricultural and forestry residues, chemical and petrochemical industry wastes, paper and pulp industry waste, food industry and biofuel production waste, water treatment residues, and other industrial wastes. It should be understood that these examples of waste products are provided by way of illustration, and not as a limitation.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items or features. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the components on a larger scale or differently shaped for the sake of clarity.

FIG. 1 is a stepwise representation of the required components of the invention.

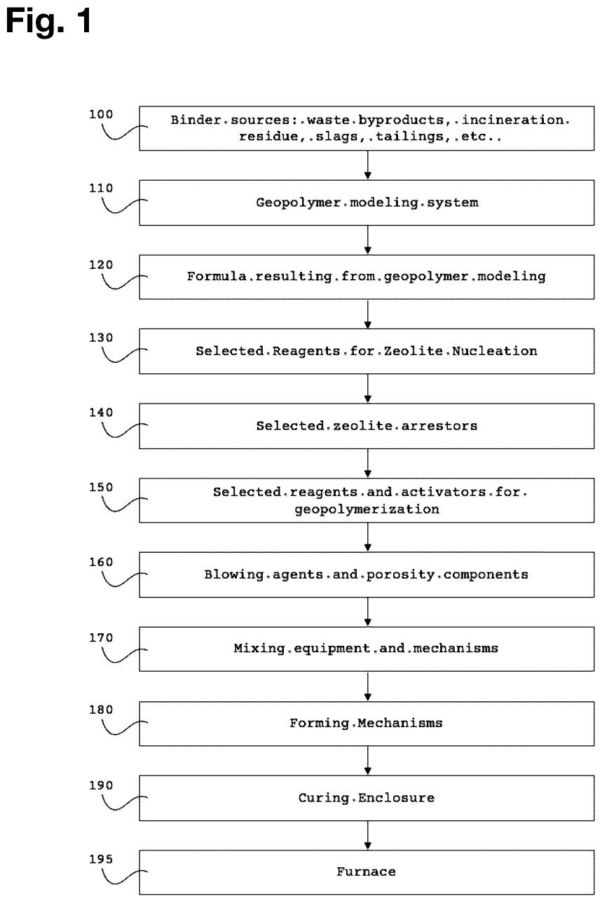

FIG. 2 is a stepwise representation of a preferred method of manufacture.

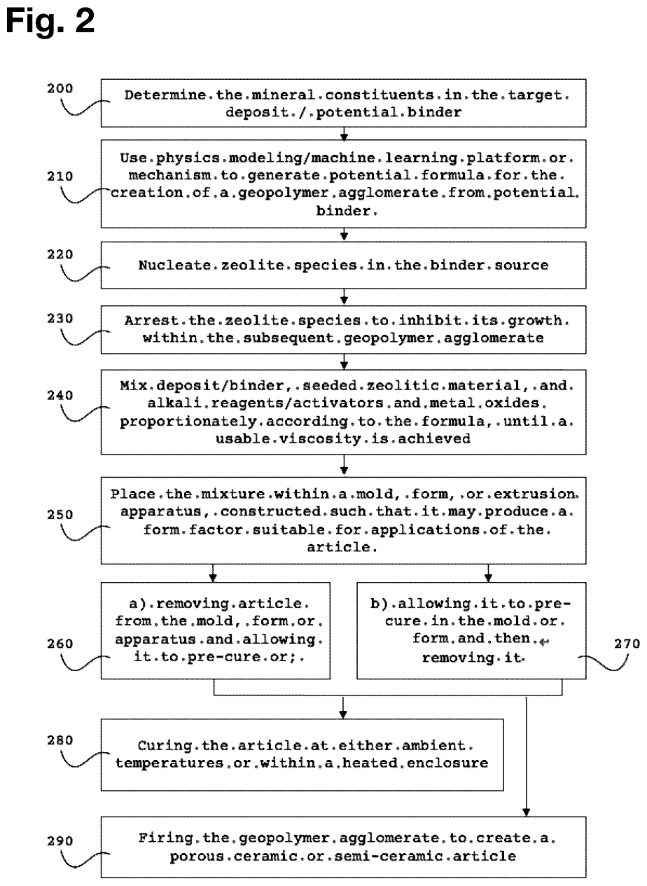

FIG. 3 is a stepwise representation of production modes.

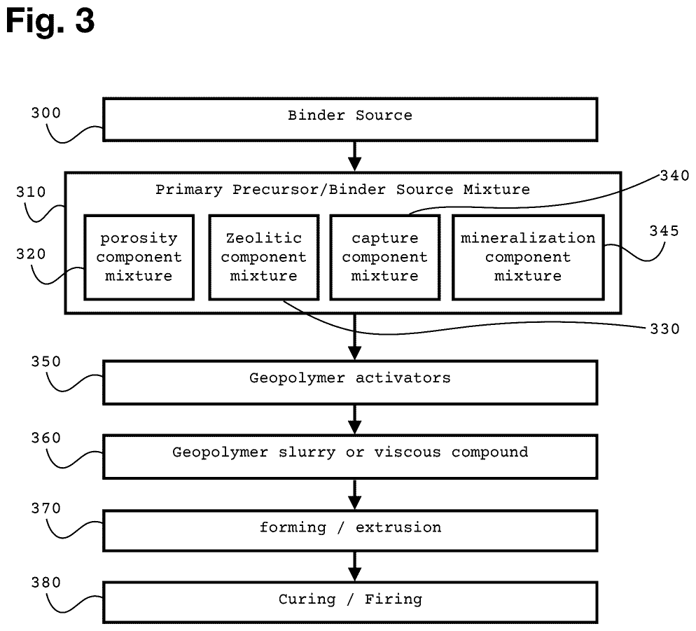

FIG. 4 is a set of representative article form factors, rendered in perspective view.

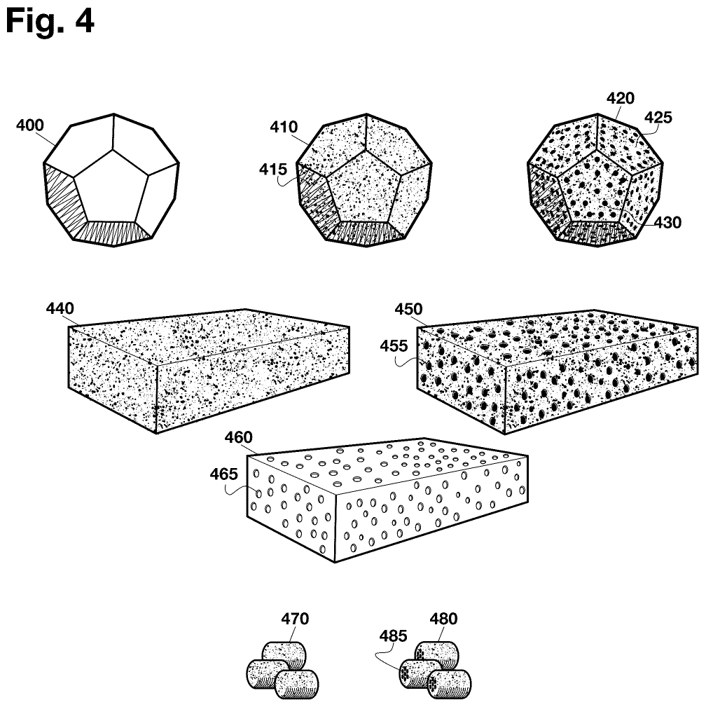

### DETAILED DISCLOSURE

Geopolymer materials incorporated with zeolites have interesting properties that merge the benefits of geopolymers and zeolites. Zeolites have a large surface area, porosity, and adsorption capacity: geopolymers provide strong and stable support structures. Thus, geopolymer-zeolite agglomerates may be used as bulk adsorbents and membranes in filtration and pervaporation processes. The use of wastes feedstocks for their manufacturing is also a sustainability advantage.

Geopolymers are generally understood as a unique class of materials composed of silicon and aluminum atoms that have bonded together with oxygen to form a complex polymer network. The process of creating geopolymers typically involves subsequent dissolution and polycondensation reactions carried out between certain types of aluminosilicate binder precursors, hereinafter referred to as binder sources, and alkaline silicate solutions (activators).

Binder sources usually have a high concentration of silica and alumina. These two elements are the essential building blocks needed for the formation of a geopolymeric network that characterizes these materials.

In this invention, alkali activators, most commonly either sodium hydroxide or potassium hydroxide, are used in the presence of sodium silicate (generally in solution) to spark and expedite first a zeolite nucleation reaction, and then a subsequent geopolymerization reaction. As the activators for each modality may vary in a given formula, those activators used to nucleate zeolites are hereinafter referred to a zeolite activators, and those used to institute component dissolution and polycondensation of geopolymers from binder sources are hereinafter referred to a geopolymer activators. These sets of reactions are responsible for generating a solid and cohesive material, which is the final product of a geopolymerization process. This is how the unique and sturdy synthetic stone is achieved. Geopolymer activators discussed herein rely aon a molar ratio of silicon dioxide to metal oxide of about 1.2 to about 1.95.

In contrast to concrete from Ordinary Portland Cement, a geopolymer agglomeration can offer advantages in terms of sustainability, durability, and mechanical properties. Certain geopolymers offer excellent chemical resistance, high strength, and enhanced durability, making them suitable for various applications in industry such as exposure to seawater or acidic solutions.

The present invention for a porous geopolymer zeolite agglomerate distinguishes itself from prior materials and practices through the utilization of readily available waste and recycled materials as zeolite nucleation and binder sources for both the geopolymer agglomerate and the zeolites components therein.

The production methods of the invention employed for the geopolymer agglomerate are easily imparted and necessitate minimal expertise, thermal or energy input, or prior knowledge, rendering them economically desirable, even without necessitating a conventional plant or factory setup.

The invention is a cost-effective method for producing unique geopolymer agglomerate articles formed and composed of readily available waste ashes, incineration residues, waste glass, and/or mining residues. Zeolites formulated (and subsequently arrested) in the agglomeration facilitate atmospheric mineralization, enabling the articles to effectively capture and store carbon or aid self-healing.

A preferred embodiment of an article resulting from the invention is an aggregate, stone, pebble, pellet, artificial pumice, or geopolymer lattice, or block (in general a cast or formed article) that may replace other such form factors that have been produced with Ordinary Portland Cement or other significantly similar material. The resulting articles utilize zeolites and evolving silicate species to sequester carbon, and or methane, and/or hydrogen, while concurrently acting as a habitat for microorganisms that aid in the conversion of gasses and other elements obtained from atmospheric and industrial exhaust sources.

A preferred embodiment effectively immobilizes harmful agents such as heavy metals, harmful chemicals, and carcinogenic agents that may be resident in the binder sources within the geopolymer, rendering those agents functionally inert though either incorporation into the zeolites which act as molecular sieves, or via component dissolution and reconstitution into a three-dimensional geopolymer network.

A preferred embodiment of this invention requires a binder source from waste materials of appreciable size to make the undertaking worthwhile and economical. The binder source contains one or both of silica or silicate materials suited to the creation of geopolymers (40-85% silica by mass) and aluminous mineral species (12 to 46% by mass), and includes other oxides or silicates suited to subsequent mineralization during and after the formation of said geopolymer articles, such as iron oxide. Viable precursor source materials for the invention include one or more of: a) mining and extraction residues: including bauxite residue, red mud, copper slag, gold mine tailings, nickel slag, phosphate sludge 100, b) coal combustion products: including fly ash, bottom ash, pond ash, coal gangue, flue gas desulfurization gypsum 100, c) metallurgical slag: including steel slag, iron slag, blast furnace slag, electric arc furnace slag, ferrochrome slag 100, d) waste from glass, ceramic and cement industries (including post-consumer): including glass cullet, glass fiber waste, spent abrasives, ceramic waste, cement kiln dust, e) power plant residues: including silica fume, desulfurization slag 100, f) construction and demolition debris: including concrete rubble, brick dust, mortar waste, asphalt pavement waste, gcopolymer waste 100, g) clay and shale processing waste: including kaolin processing waste, ball clay processing waste, earth processing waste, processing waste 100, h) agriculture and forestry residues: including rice husk ash, bagasse ash, bamboo ash, olive mill waste ash, i) chemical and petrochemical industry wastes: including sodium silicate residue, sodium aluminate residue, montmorillonite 100, j) paper and pulp industry waste: including paper sludge ash, bark ash, black liquor, green liquor 100, k) food industry and biofuel production waste: including spent grain ash (from breweries), coffee husk ash, empty fruit bunch ash (from palm oil production), spent mushroom compost ash 100, l) water treatment residues: including water treatment plant sludge, alum sludge 100, m) other industrial wastes: including perlite waste, waste, wollastonite waste, asbestos waste, talc waste, mica waste 100. Again, it should be understood that these binder sources are provided by way of illustration, and not as a limitation.

In the absence of higher quality binder source materials (those with a high ratio of either silica or alumina), less desirable (due to environmental impact) binder components, namely mined components, may be included as binder sources 100. By adding in a balance of species of basalt, species of serpentine, species of zeolites, and species of clay and diatomaceous earth, the ratios of silica and alumina in the overall binder mix are brought within an acceptable range for the manufacture of the invention.

In a preferred embodiment, the invention further includes one or more zeolite nucleation activators 130 from the list of sodium hydroxide, potassium hydroxide, sodium silicate, potassium silicate, sodium aluminate, hydrochloric acid, sulfuric acid, sodium carbonate, sodium bicarbonate, phosphoric acid. 130. It should be noted that the zeolite activators all are in the set of geopolymer activators 150. Put another way, the same activators (in different measures applied at and for different times) will either form zeolites after an incubation period (a small amount of activator, such that the binder precursor is treated with the zeolite activator by fractionally hydrating, but not drenching or soaking the binder source and then allowing several hours/days for nucleation and initial growth to occur) or geopolymers (a much larger amount of the same activators such that a geopolymer slurry is formed) in a shorter time frame, setting and initially curing in minutes or hours. The application of the zeolite activator for zeolite nucleation is 0.1 to 0.005 the weight of the binder source, with the zeolite activator being in solution with water.

This invention further requires, for polymerization, one or more geopolymer activators 150 to react with the binder source. These geopolymer activators are either alkali or acid-based, and are from the set of sodium hydroxide, potassium hydroxide, sodium silicate, potassium silicate, sodium carbonate, potassium carbonate, sodium bicarbonate, potassium bicarbonate, sodium aluminate, potassium aluminate, sodium phosphate, potassium phosphate, sodium borate, potassium borate, sodium lignosulfonate, potassium lignosulfonate, sodium acetate, potassium acetate, sodium citrate, potassium citrate, sodium oxalate, potassium oxalate, sodium sulfate, potassium sulfate, sodium formate, potassium formate, sodium glycolate, potassium glycolate, sodium pyrophosphate, potassium pyrophosphate, sulfuric acid, phosphoric acid, hydrochloric acid, nitric acid, acetic acid, formic acid, citric acid, oxalic acid, tartaric acid, and lactic acid. These are hereinafter referred to as geopolymer activators 150. Again, it should be understood that these geopolymer activators are provided by way of illustration, and not as a limitation.

Alkali-based (and other) geopolymer activators 150 break down the aluminum and silicon atoms in the binder source materials 100 through an ion exchange process when mixed, leading to the dissolution of the binder materials and subsequent formation of a geopolymer network.

Acid-based geopolymer activators 150 primarily operate by protonating the alumina and silica species of the binder source when mixed to form soluble aluminum and silicon atoms. This protonation process also leads to the dissolution of the source materials, and subsequent geopolymerization of the agglomeration.

The geopolymer activator 150 is in solution with a pH ≥10, and a is mixed at a ratio of binder source 100 to geopolymer activator 150 from about 2:1 to about 3.5:1.

In a preferred embodiment, this invention further incorporates zeolite arrestors 140 into the mixture of the binder sources (having been activated to produce zeolites), to stop zeolites from continuing to grow in the zeolitic agglomeration. These zeolite arrestors 140 can include one or more from the set of organosilanes, Tetrapropylammonium bromide, Tetraethylammonium bromide, Polyvinyl-alcohol, Polyethylene glycol, ethanol, isopropanol, glutamic acid, nitric acid, phosphoric acid, propylamine, butylamine, ethylene glycol, and propylene glycol 140. Additionally or in substitution, one or more sulfer compounds may be utilized, from the set of Thiourea, Sulfuric Acid, Sulfurous Acid, Sodium Metabisulfite, Hydrogen Sulfide 140. These are hereinafter referred to as zeolite arrestors. Arresting the zeolites after initial formation by introducing a zeolite arrestor either as a dry component and then wetting the combined material, or by bringing the nucleated zeolites in contact with an arrestor that is in solution, but prior to the creation of a geopolymer, results in the arrested zeolite having and retaining beneficial properties that would otherwise, if the zeolite was permitted to continue to mature, be deleterious to the strength of any evolving geopolymer containing said zeolite.

In a preferred embodiment this invention further includes mechanisms for direct synthesis pore formation 160, including addition into the mixture of one or more powders (typically a combination of an inorganic and an organic) with particle distributions predominantly from 0.01 μm to 125 μm from the set of aluminum, aluminum oxide, zinc, zinc oxide, iron, iron (III) oxide, silicon, silicon dioxide, magnesium, magnesium oxide, titanium, titanium dioxide, saponin, yucca extract, lecithin, rhamnolipids, and sophorolipids 160. These are hereinafter referred to as porosity components or direct synthesis porosity components. Again, it should be understood that these porosity components are provided by way of illustration, and not as a limitation.

In a preferred embodiment, this invention further includes one or more powdered components capable of capturing CO2 or other greenhouse gasses added into the mixture. These capture components 340 can be one or more from the set of zeolites, layered silicates, aluminosilicates, cyclosilicates, calcium silicates, magnesium silicates, sodium silicates, silicate glass, wollastonite, olivine, serpentinite, forsterite, glauconite, clinoptilolite, feldspars, sodalite, chrysotile, sepiolite, meerschaum, tobermorite, sodium metasilicate, lithium metasilicate, potassium metasilicate, barium metasilicate, strontium metasilicate, calcium metasilicate, magnesium metasilicate, beryllium metasilicate, zinc metasilicate, copper metasilicate, aluminum metasilicate, cobalt metasilicate, iron metasilicate, nickel metasilicate, lead metasilicate, manganese metasilicate, cadmium metasilicate, antimony metasilicate, silver metasilicate, tin metasilicate, lithium oxide, barium oxide, strontium oxide, beryllium oxide, cerium oxide, titanium dioxide, zirconium dioxide, and hafnium oxide 340. These are hereinafter referred to as capture components. Again, it should be understood that these reactive agents are provided by way of illustration, and not as a limitation.

In a preferred embodiment, this invention further includes one or more powdered components capable of continued mineralization 345 within a porous geopolymer zeolite agglomerate, including but not limited to waste cement, olivines, serpentines, halloysites, zeolites, wollastonite, clays, or diatomaceous earth 345. Again, it should be understood that these reactive agents are provided by way of illustration, and not as a limitation.

Source materials, to be used and a primary and binder source are identified and procured 100. A formulary modeling process, including a computer system for modeling novel and performant formulas 110, or an existing formula 120, matches the source materials with the appropriate zeolite activator(s) to attain zeolite nucleation 130, selected zeolite arrestors to inhibit or suppress further zeolite growth 140, selected reagents and activators for geopolymerization of the source material 150, selected blowing agents and porosity components 160, mixing equipment and mechanisms appropriate for mixing both the zeolite material and activators as well as binder sources and activators, for mixing both wet and dry fractions of these materials 170, Forming mechanisms and components or mechanical processes are selected and implemented for article formation from a set of molds, forms, or extruders and extrusion dies 180. Some agglomerations created using the invention can be cured at ambient temperatures while some may benefit from curing within a curing enclosure 190 capable of accommodating temperatures from ambient to 185° C. 190. Optionally a furnace or kiln 195 capable of firing the geopolymer agglomerate articles from 186 to 950° C. may be used depending on formulary.

Initially, the binder source material 100 is evaluated to determine a volume and disposition of contributory elements contained within the sample. Comprehensive analysis 200 is conducted and may generally involve the use of advanced analytical techniques such as X-ray fluorescence (XRF), X-ray diffraction (XRD), and scanning electron microscopy (SEM) coupled with energy-dispersive X-ray spectroscopy (EDS). XRF is used to determine the elemental composition of the deposit; XRD is employed to analyze the mineralogical composition of the deposit; SEM provides high-resolution images of the sample's surface; EDS enables the identification and mapping of elements present in specific areas of interest.

To create the geopolymer agglomerate in accordance with this invention; a) select binder source 100 material(s) (from the set of various industrial wastes and residues) b) characterize the source materials 100 as a viable precursor “as-is” or as requiring additions of other compounds or components to become viable, these compounds or components generally sourced from the known list of binder sources 100, as sources of silica and or aluminum and or other components such as porosity components 160, and capture components 340, or mineralization components 345 as required to form the target geopolymer according to a formula derived from physics modeling/machine learning 210; c) Nucleate zeolite species in a portion of the binder source material 220 and then arrest said nucleation and zeolite growth with one or more zeolite arrestors 140 230; d) select a porosity component 160 or components appropriate to the objectives of the agglomeration capable of direct synthesis of porosity in geopolymers either by means of alkali reaction and dissolution to hydrogen gas or through desiccation. A particle of a porosity component 160 that is 50 μm will result in a pore openings or cells of between about 15 μm to 45 μm in diameter if the pore formation is the result of desiccation, and between about 50 μm to 400 μm in diameter if it is the result of gasification; e) mix the binder source materials 100 with the geopolymer activators 150 identified by the target formula until a unified and viscous mass is obtained 240; f) place the mixture in a mold, form, or extrusion apparatus 250; g) upon the mixture solidifying to a state whereby it may be moved without marring, remove the geopolymer agglomerate article from the mold, form or apparatus and allow it to pre-cure 260; h) optionally allowing it to pre-cure before removal from a mold or form 270; then optionally curing the article at ambient or elevated temperatures, 280 or firing the article at temperatures of about 186° C. to 950° C. and soak time of about 30 minutes to 4 hours depending on the size of the articles, to create a porous ceramic or semi-ceramic article 290.

Once the requisite binder source 100 and zeolite precursor source materials 100 have been analyzed, a physics-based modeling and machine learning approach is employed to create a comprehensive framework for optimizing geopolymer recipes into target formulas 210. Due to the intricate nature of geopolymers and alkali-activated materials, target formulations for stable and desirable geopolymer agglomerates from waste materials cannot easily be accurately predicted through simple mathematical calculations or geochemical literature. Instead, advanced physics modeling techniques and machine learning, or alternatively, complex matrices, indexes, and lookups must be employed 210. These techniques take into account various factors such as additive measures, thermal elements, hydration elements, oxidation elements, surface area, curing physics, and other parameters, this should not be considered an exhaustive list of such parameters, but should be considered representative in nature.

Various inputs such as, but not limited to; source material characterization 200, the availability and accessibility of required source materials 100 and precursor components 130, 140, 150, 160, 320, 330, 340, 345, economic viability, reactive surface area, porosity requirements, and end-use criteria are considered. A production run may or may not require characterization and analysis of a binder source material 200, if said material has been previously characterized and incorporated into a physics model 210. The requisite requirements to turn the binder source 100 into the target geopolymer agglomerate 400-485, will already be known. By incorporating target parameters, along with data derived from characterization of the source material and subsequent modeling, viable formulas and recipes can may be identified based on their ability to meet the desired criteria or target characteristic of a subsequent agglomerate 400-485.

The physics-based modeling aspect 210 of this approach allows for understanding of the underlying chemical and physical processes involved. Simulating these processes, shows the behavior of different compositions to allow identification of optimal combinations of ingredients. In this approach, multiple constituents within the binder sources 100 are targeted for mineralization, which serves as another means of differentiating this invention from other technologies that focus on singular reactions. Certain geopolymer activators 150 and additional added ingredients may react favorably with one binder source material constituent, facilitating mineralization, but may also have adverse reactions with other activators and additions that target different source material constituents. This interplay between different activators 130, 150 and their interactions with various source material constituents 320-345 must be managed to attain the objectives of the agglomerate item—a further objective of the AI physics modeling 210.

For example, two binder sources 100 of sufficient size to be economically viable may be characterized 200. The sources are characterized and it is determined that source A contains nucleated zeolites due to weathering (saving a processing step) and the other (source B) does not. Source A, however, is low in silica, and needs an addition of waste-glass or other highly silicious binder source to make it viable, and the glass must be transported over one hundred miles. Source B is high in silica and needs no binder additions. Therefore, to produce a finished geopolymer-zeolite agglomerate, the model would encourage that Source B be utilized, as instituting Zeopolymer nucleation and arrest is more economically desirable than arresting the existing zeolite growth and transporting and processing the waste-glass addition 210.

Should a target formulation 120 call for zeolites to be produced from the binder source prior to production of the finished articles, a process of nucleation may be enacted by mixing a portion of the source material together with a suitable zeolite activator 220. The zeolite activator 130 to binder source ratio depends on the desired zeolite type, for example a solution of 10% NaOH applied to Class F fly ash is likely to produce Zeolite A.

The mixture of the zeolite activator 130 and zeolite precursor material (binder source) is heated to a temperature range at or about from, 23-200° C., under autogenous pressure. This promotes a dissolution reaction (a breaking apart of silicon and hydrogen molecules) within the binder source material and makes these molecules available for zeolite crystal formation. [“dissolution reaction” should be sufficient, know term in the space]. As the reaction mixture reaches a saturation state, nucleation occurs 220. Dependent on the binder characterization and the ratio of zeolite activator 130 to binder source 100, this process of zeolite nucleation takes from 6 to 144 hours 220.

A preferred objective is to create a formulation 120 and a mixture that subsequently mineralizes and captures CO2, or Methane, or Hydrogen, but also maintains the functionality and durability of the resulting required article.

To render them the most useful and more stable for use in the target agglomerate, the growth of nucleated zeolites to be utilized in a zeolite geopolymer agglomerate is arrested prior to maturity by means of one or more of the following methods 240: a) introduction of certain organic molecules into the mixture after zeolite nucleation, such as long-chain alcohols, amines, and carboxylic acids, to inhibit the growth of zeolite crystals by adsorbing onto the crystal surfaces and hindering the attachment of new building units 140, 230; b) introduction of certain metal ions into the mixture after zeolite nucleation, such as aluminum, iron, nickel, manganese, and copper, to act as growth inhibitors for zeolites by substituting for the framework elements in the zeolite structure, leading to stunted crystal growth or even complete inhibiting said growth 140, 230; c) introduction of certain sulfates and thiosulfates into the mixture after zeolite nucleation to inhibit zeolite growth by replacing cations in the solution through ion exchange, leading to the formation of soluble sulfate complexes with metal cations, preventing their incorporation into the growing zeolite crystal lattice 140, 230; d) counter intuitively, introduction of silica nanoparticles into the mixture inhibit the growth of zeolite crystals by physically blocking the crystal growth sites or by adsorbing onto the crystal surfaces and interfering with the attachment of new building units 140, 230.

In a preferred embodiment, selected geopolymer activators 150 are derived from a class of user friendly (may be handled safely) alkaline reagents which may include, but are not limited to, sodium and potassium soluble silicates, sodium silicate, sodium carbonate, sodium aluminate, and sodium metasilicate 150. In other embodiments, calcium oxide, sodium hydroxide and potassium hydroxide may be used as geopolymer activators 150, when the objectives include fast initial strength and hardening, despite drawbacks of using these activators, including the need for protective equipment and extended safety measures.

The invention requires that the binder source 100, optionally with the seeded/arrested zeolite material 330, the mineralization materials 345, and porosity component 320 be mixed such that they obtain a desirable and workable viscosity 240. The incorporation of sand and aggregate-sized mineralization constituents enhances the reactivity and mineralization potential of the material by providing both silica and alkali source reservoirs. By including porosity components, a significant amount of void space may be created within the agglomeration, thereby increasing the reactive surface area available for chemical reactions to occur. This is particularly advantageous as it allows for a higher degree of mineralization after curing 280 and allows pathways for autogenous healing and nucleation sites for silicate species and promotes the formation of stable and durable structures.

The method of the invention further includes placing the mixture within a mold, form, or brick manufacturing apparatus or extruder 250 to create a geopolymer article from the agglomerate. The apparatus should be designed to produce the desired form-factor of the final article. The mixture 310 is carefully poured or injected into the apparatus and allowed to take the shape of the mold or form 250. The apparatus may have adjustable parameters to control the size, shape, and density of the resulting article. Alternatively, the mixture 310 may be extruded onto a surface into a shape.

Once the geopolymer agglomerate has undergone a setting process, it attains sufficient mechanical integrity to withstand transportation without experiencing substantial deformations or deteriorations in its original shape, it may begin a cure or pre-cure phase. This step may be performed in two ways:

Removing the article from the mold, form, or apparatus and allowing it to pre-cure—it is left to set for a certain period of time to solidify, such that is it a solid body and may be handled and transported without obvious deformation 260; conversely, it may be left in the mold, allowing the article to pre-cure, removing it after it has substantially solidified. In this approach, the geopolymer mixture is poured into the mold or form and left to pre-cure while still inside. After the pre-curing period, the article is taken out of the mold or form and may be subjected to further processing 270.

The curing process for the article may either occur at ambient temperatures or elevated temperatures: a) with ambient curing, the article is allowed to cure naturally at room temperature without the need for any external heat source. The curing period for this process may range from about twenty-four hours to twenty-eight days, depending on the desired strength and durability of the final product. b) Alternatively, the article may be cured within a heated vessel or enclosure. The temperature range for this curing process may be between 60° C. to 185° C. The curing period may also vary based on the specific requirements, but it generally falls within a range of or about one hour to twenty-eight days 280.

For some use cases, following pre-curing, it is appropriate that the agglomerate be further heated or fired allowing for further crystal formation and the evolution of glass phases. In these instances, it may be placed in a furnace or kiln for a time with temperatures ranging from 186 to 950° C. 290. This results in a geopolymer agglomerate article of higher strength and durability than those that rely solely on curing.

To ensure enablement of the invention it should be understood that according to a generic formula and prevailing practice, certain proportions may be variable in accordance with the needs of the binder source to institute the proper chemical and structural characteristics required by the eventual article and are herein expressed as ranges. This variability does not constitute an invitation to experimentation as the final formulation will be comprised in accordance with a formula specified by the model 120.

The generic procedure for creation of a porous zeolite geopolymer agglomerate in adherence with this invention starts with a binder source 300 which has been pulverized and milled to a size distribution ranging from 0.5 μm to 125 μm and comprises 80% to 94% of the primary precursor mixture 310 wherein at least a portion of binder source has been introduced to and mixed with one or more porosity components with a size distribution ranging from 0.01 μm to 125 μm and in a range of 1-7% the overall said portion's weight to comprise porosity components 320; and at least a portion of said binder source has been seeded with zeolites by means of introducing a zeolite activator into the mixture then allowing it to rest at 23-200° C. under autogenous pressure for 6 to 144 hours, thereafter arresting the zeolite growth 330; and at least a portion of the binder source has been combined with one or more capture components in a range of 4-11% the overall binder source's weight 340 The combined binder source mixture (binder source, zeolitic portion, porosity portion, and capture portion) is agitated to uniformity and introduced to one or more gcopolymer activators 350 at ratios ranging from 0.4 parts geopolymer activator 150 including water and 1 parts combined binder source by weight, to 2.5 parts geopolymer activator 150 by weight (including water) and 1 parts combined binder source 300 by weight. This combination of materials (binder portions and activators) is mixed together ranging from 2 to 15 minutes to comprise a uniform geopolymer slurry 360. The geopolymer slurry is then formed or placed within an extruder and expelled 370. After setting or pre-curing it is then cured or fired 380.

In alternative embodiments, pore forming techniques for porous geopolymer zeolite agglomerates may be achieved through direct foaming, sacrificial templating, and additive manufacturing. Direct foaming is injecting gas into a geopolymer slurry prior to forming, resulting in the evolution of vesicular pores as the geopolymer sets. Solution-based compounds like hydrogen peroxide or hypochlorites and perborates may also be used as effective additives to the mixture to achieve these results.

Sacrificial template methods rely on the dissolution of a porosity component such as wax, paper, gel or starch beads or rods that have been added to the geopolymer slurry. Dissolution occurs during the geopolymer setting process or through extraction methods such as melting, decomposition, pyrolysis, sublimation, or acid leaching. This approach allows for the creation of porous structures by removing the template material, and leaving the pores intact.

A mixture made pursuant to the invention can be used in additive manufacturing methods involve the use of 3D printing or extrusion techniques to deposit geopolymer slurry or powders.

Replica templating is another approach where a highly porous polymeric, gel, or starch sponge or lattice is initially soaked in a geopolymer suspension. The geopolymer slurry material fills in the internal pores of the sponge, and is allowed to dry and cure, creating a porous geopolymer agglomerate with a high porosity after the sponge lattice is removed via heat, desiccation, or is dissolved using a solvent.

Geopolymer agglomerates can be given a multitude of form factors suited to their end use. These form factors are initially arrived at via molding, casting, or extruding and can be further machined from there. Initially, and without the addition of porosity components or process methods, geopolymer agglomerate articles 400 are predominately nanoporous and appear exceedingly solid. With the addition of pore forming components, they take on a porosity 410 where the pore openings maintain an organic but near uniform distribution 415 of a mesoporous nature. Once created, such articles 420 can be further processed or machined to to incorporate both the mesoporous distribution 425 and an engineered macroporous distribution 430. Such articles are exceedingly useful for remediation and filtration media, where size and porosity impacts flow rates and efficacy. Mesoporous geopolymer agglomerate construction articles (like blocks or pavers) 440 double as both articles for environmental engineering, capable of capturing CO₂ and filtering contaminates, and lightweight but durable construction materials. The same paver 450 with the addition of a pattern of macro pores 455 and capture components, becomes an article capable of direct air capture and sequestration of carbon. The same can be done, in an even lighter version 460 by employing a sponge-like sacrificial template 465 for the geopolymer slurry, which then hardens into an efficient air filter.

Geopolymer agglomerates are also well suited to extrusion. While this can include bricks, beems, bars and sheets, it can also include beads, uniform aggregates, and prill 470. An advantage of extrusion is that extrusion dies can produce mesoporous articles 480 with machined and uniform macro pores 485.

All these form factors, aside from the sacrificial template 460 can be used, generally after crushing, as lightweight filtration and construction aggregate.

Upon any eventual recycling of articles incorporating the invention, the articles may be either thermally or chemically treated, particularly if they have sequestered useful materials to be harvested in such a manner, or chopped and ground, and then either reused directly or utilized as a raw material for subsequent geopolymeric applications.

In a preferred filtration embodiment, the porous structure of the articles incorporating the invention allows for effective filtration of gases, liquids, or solid particles via vesicular corridors and porous void spaces. The specific composition and pore size distribution may be optimized to target specific contaminants or pollutants. For example, the pore structure for capturing microbiologies is requires a macroporous structure whereas the capture of CO2 requires nano and mesoporous structures.

In remediation applications, articles incorporating the invention are used to capture and immobilize contaminants from entering soil or groundwater. The geopolymer matrix binds heavy metals, organic pollutants, or radioactive elements, preventing their migration and reducing the environmental impact.

For sequestration applications, articles incorporating the invention are designed to capture and store greenhouse gas constituents such as carbon dioxide (CO2), nitrous oxide (N2O), methane (CH4), or fluorinated gases. The porous structure provides a large surface area for adsorption or absorption of these gases by the zeolites, effectively reducing the presence of the gases in the atmosphere.

While various examples and embodiments are described individually herein, the examples and embodiments may be combined, rearranged and modified to arrive at other variations within the scope of this disclosure.

Although embodiments have been described in language specific to structural features and/or methodological acts, it is to be understood that the disclosure is not necessarily limited to the specific features or acts described. Rather, the specific features and acts are disclosed herein as illustrative forms of implementing the claimed subject matter. Each claim of this document constitutes a separate embodiment, and embodiments that combine different claims and/or different embodiments are within the scope of the disclosure and will be apparent to those of ordinary skill in the art after reviewing this disclosure.

1. A method for producing a geopolymer article comprising:
weighing at least one binder source from a set of waste materials or industrial byproducts that includes aluminum and silica atoms, one or more porosity components, and one or more capture components;
Applying a zeolite activator to incite zeolite nucleation within at least a portion of the binder source;
Incubating treated binder source to incite initial zeolite formation from the nucleated zeolite;
applying a zeolite arrestor to suppress or halt further zeolite formation;
applying a geopolymer activator to the binder source in a range of 0.4 to 2.5 geopolymer activator by weight to 1.0 binder source by weight;
mixing the geopolymer activators and binder source until the mixture becomes of a useful viscosity for forming and shaping;
forming an article from the mixture;
allowing the article to cure.

2. The method of claim 1 where a binder source comprises one or more from the set of:
coal combustion products, fly ash, bottom ash, pond ash, coal gangue, flue gas desulfurization gypsum, power plant residues, silica fume, desulfurization slag, construction and demolition debris; concrete rubble, brick dust, mortar waste, asphalt pavement waste, geopolymer waste, clay and shale processing waste, agriculture and forestry residues, rice husk ash, bagasse ash, bamboo ash, olive mill waste ash, chemical and petrochemical industry wastes; sodium silicate residue, sodium aluminate residue, montmorillonite, paper and pulp industry waste, paper sludge ash, bark ash, black liquor, green liquor, food industry waste, biofuel production waste, spent grain ash, coffee husk ash, empty fruit bunch ash, spent mushroom compost ash, water treatment residues; water treatment plant sludge, and alum sludge, waste from glass, ceramic and cement industries (including post-consumer); glass cullet, glass fiber waste, spent abrasives, ceramic waste, and cement kiln dust, mining and extraction residues; bauxite residue, red mud, copper slag, gold mine tailings, nickel slag, phosphate sludge, perlite waste, waste, wollastonite waste, asbestos waste, talc waste, mica waste metallurgical slag, steel slag, iron slag, blast furnace slag, electric arc furnace slag, and ferrochrome slag.

3. The method of claim 1 where the porosity component comprises one or more from the set of:
aluminum, aluminum oxide, zinc, zinc oxide, iron, iron (III) oxide, silicon, silicon dioxide, magnesium, magnesium oxide, titanium, titanium dioxide, saponin, yucca extract, lecithin, rhamnolipids, and sophorolipids.

4. The method of claim 1 wherein the geopolymer activator comprise one or more from the set of:
sodium hydroxide, potassium hydroxide, sodium silicate, potassium silicate, sodium carbonate, potassium carbonate, sodium bicarbonate, potassium bicarbonate, sodium aluminate, potassium aluminate, sodium phosphate, potassium phosphate, sodium borate, potassium borate, sodium lignosulfonate, potassium lignosulfonate, sodium acetate, potassium acetate, sodium citrate, potassium citrate, sodium oxalate, potassium oxalate, sodium sulfate, potassium sulfate, sodium formate, potassium formate, sodium glycolate, sodium pyrophosphate, and potassium pyrophosphate, sulfuric acid, phosphoric acid, hydrochloric acid, nitric acid, acetic acid, formic acid, citric acid, oxalic acid, tartaric acid, and lactic acid.

5. The method of claim 1 wherein the capture component comprises one or more powders from the set of:
zeolites, layered silicates, aluminosilicates, cyclosilicates, calcium silicates, magnesium silicates, sodium silicates, silicate glass, wollastonite, olivine, serpentinite, forsterite, glauconite, clinoptilolite, feldspars, sodalite, chrysotile, sepiolite, meerschaum, tobermorite, sodium metasilicate, lithium metasilicate, potassium metasilicate, barium metasilicate, strontium metasilicate, calcium metasilicate, magnesium metasilicate, beryllium metasilicate, zinc metasilicate, copper metasilicate, aluminum metasilicate, cobalt metasilicate, iron metasilicate, nickel metasilicate, lead metasilicate, manganese metasilicate, cadmium metasilicate, antimony metasilicate, silver metasilicate, tin metasilicate, lithium oxide, barium oxide, strontium oxide, beryllium oxide, cerium oxide, titanium dioxide, zirconium dioxide, and hafnium oxide.

6. The method of claim 1 wherein the zeolite arrestor comprises one or more from the set of:
organosilanes, tetrapropylammonium bromide, tetraethylammonium bromide, polyvinyl-alcohol, polyethylene glycol, ethanol, isopropanol, glutamic acid, nitric acid, phosphoric acid, propylamine, butylamine, ethylene glycol, and propylene glycol, thiourea, sulfuric acid, sulfurous acid, sodium metabisulfite, and hydrogen sulfide.

7. The method of claim 1 where the binder source comprises:
a range of at least 40-85% silica by mass.

8. The method of claim 1 where the binder source comprises:
a range of at least 12 to 46% aluminous species by mass.

9. The method of claim 1 wherein
a formula is used to optimize the resulting article's ability to capture various elements and compounds.

10. The method of claim 1 wherein
a formula is used to optimize target structural characteristics imparted on resulting articles from the binder source, zeolites, oxides, and activator constituents.

11. The method of independent claim 1, with the addition of an ingredient or ingredients from the set of:
waste cement, olivine, serpentine, zeolites, halloysite, wollastonite, diatomaceous earth, and kaolinitic clays.

12. The method of claim 1 wherein the geopolymer activator has a molar ratio of silicon dioxide to metal oxide of about 1.2 to about 1.95.

13. The method of claim 1 wherein:
The mixture is subjected to direct foaming, dissolution, additive manufacturing, or sacrificial templating to induce porosity.

14. The method of claim 1 wherein the zeolite nucleation occurs between about 23° and 200° C.

15. The method of claim 1 wherein the articles cure:
by means of ambient temperature, or by placement of the article within a heated vessel or facility at or around 60° C. to 185° C., where the curing period is from one hours to twenty-eight days.

16. A method for producing a geopolymer article comprising:
Providing target geopolymer agglomerate characteristics to an AI model and characterizing the binder source
weighing at least one binder source from a set of waste materials or industrial byproducts including aluminum and silicon atoms and also including one or more porosity components;
establishing a formula according to the model;
applying a geopolymer activator to the binder source in a range of 0.4 to 2.5 geopolymer activator by weight to 1.0 binder source by weight;
mixing the geopolymer activator and the binder source until the mixture becomes of a useful viscosity for forming and shaping;
forming an article from the mixture;
allowing the article to cure.

17. The method of claim 16 wherein the AI model is replaced with a lookup table or index.

18. An article resulting from the methods of claims 1-17 wherein the article is formed via molding, casting, extruding, machining or crushing to incorporate the physical characteristics of a commercially desirable stone species or agglomerate.

19. An article resulting from the methods of claims 1-17 wherein the article is a synthetic stone, which, due to its mesoporous to macroporous vesicular pore structure, creates an optimal microbiome for flora, fauna, and fungi.

20. An article resulting from the methods of claims 1-17 wherein the article is a lightweight aggregate.
